(19) United States
(12) Patent Application Publication
(10) Pub. No.: US 2014/0188995 A1
(43) Pub. Date: Jul. 3, 2014

(54) Predictive Caching in a Distributed Communication System

(71) Applicant: FUTUREWEI TECHNOLOGIES, INC., Plano, TX (US)

(72) Inventors: Paul Fullarton, Sunnyvale, CA (US); Sujay Datar, San Jose, CA (US)

(73) Assignee: Futurewei Technologies, Inc., Plano, TX (US)

(21) Appl. No.: 13/730,544

(22) Filed: Dec. 28, 2012

(51) Int. Cl. H04L 29/08

(52) U.S. Cl. CPC H04L 67/22
USPC 709/204

(57) ABSTRACT

A method for managing information stored to a local cache comprises obtaining social network information and/or collaboration history information for a user and using the social network information and/or the collaboration history information to identify potential targets of communication for the user. The local cache is updated based at least in part on the identified potential targets of communication. Also disclosed is an apparatus for managing information stored to a local cache. The apparatus comprises an analytics engine component and an updating component. The analytics engine component is configured to determine metrics for potential targets of communication using social networking information and/or collaboration history information, and the updating component is configured to remove information corresponding to at least one of the potential targets from the local cache using the metrics.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A communications network may include nodes connected by links that enable communication between users. Each node in a network has a unique identifier (e.g., an Internet Protocol (IP) address) that enables data or connections to be routed to the correct recipient. Communications networks commonly rely on statically configured connectivity and routing, which can be manual, error prone, and rigid. Additionally, communications networks may require communication across different locales (e.g., across a wide area network). This cross-locale traffic can increase communication costs and decrease network performance, for example by increasing system latency.

### SUMMARY

In one embodiment, the disclosure includes a method for managing information stored to a local cache. Social networking information and/or collaboration history information for a user is obtained and is used to identify potential targets of communication for the user. The local cache is updated based at least in part on the identified potential targets of communication.

In another embodiment, the disclosure includes an apparatus for managing information stored to a local cache. The apparatus comprises an analytics engine component and an updating component. The analytics engine component is configured to determine metrics for potential targets of communication using social networking information and/or collaboration history information, and the updating component is configured to add or remove information corresponding to at least one of the potential targets from the local cache using the metrics.

In yet another embodiment, the disclosure includes an apparatus for managing information stored to a local cache. The apparatus comprises a processor that is configured to determine a potential communication target for a user, calculate a probability value that represents a likelihood that the user will communicate with the potential communication target, and update the local cache based at least in part on the calculated probability value.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a distributed communication system.

FIG. 2 is a schematic diagram of an embodiment of a distributed system that utilizes social network information and collaboration history information to store information to a local cache.

FIG. 3 is a schematic diagram of a local cache.

FIG. 4 is a schematic diagram of an embodiment of a system that can be used to predictively cache information in a distributed communication system.

FIG. 5 is a schematic diagram of an embodiment of a general-purpose computer system.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents. While certain aspects of conventional technologies have been discussed to facilitate the present disclosure, applicants in no way disclaim these technical aspects, and it is contemplated that the present disclosure may encompass one or more of the conventional technical aspects discussed herein.

Disclosed herein are systems and methods that enable predictive caching in a distributed communication system. In one embodiment, social network and collaboration history information are utilized to determine what communication routes are most likely to be required, and a local cache can then store the needed routing information. For example, communications may be more likely to occur between users that are linked in a social network or between users that have collaborated in the past. Accordingly, social network and collaboration history information can be used to predict what routing information is most likely to be needed at a local cache. This may be beneficial in reducing system latency and cross-locale communications (e.g. communications across a wide area network) by reducing the amount of routing information that needs to be obtained from remote sources. In another embodiment, social network and collaboration history information are utilized to distribute users in a communications system. For instance, users that are linked in a social network or have a history of collaborating may be associated with a same node (e.g., a same local server). Therefore, users that are more likely to communicate with each other can be associated with a same node, and this may also be beneficial in reducing system latency and cross-locale communications. Additionally, embodiments may reduce overall use of system resources, thereby increasing the scalability of a multi-node system.

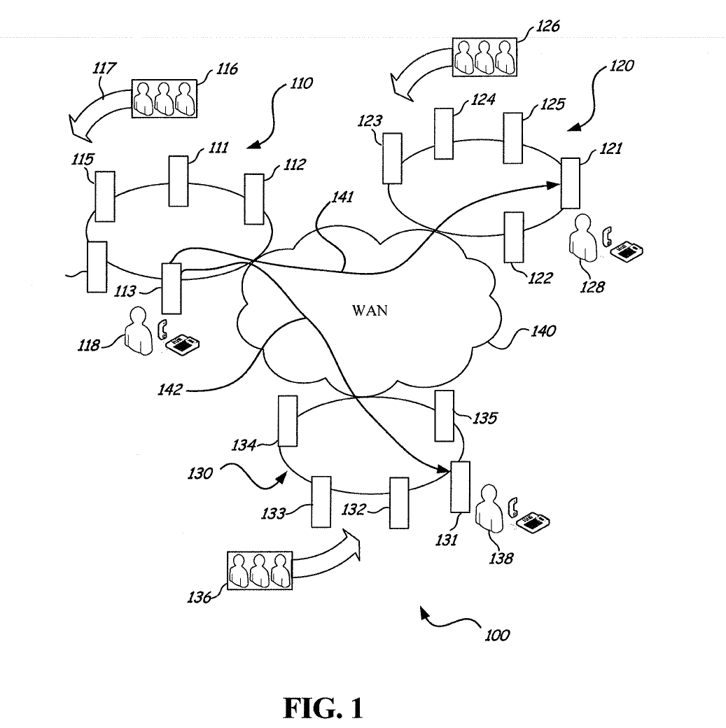

FIG. 1 is a schematic diagram of an embodiment of a distributed communication system 100. System 100 includes a first group of nodes 110 in a first locale, a second group of nodes 120 in a second locale, and a third group of nodes 130 in a third locale. The first group of nodes 110 includes the nodes 111, 112, 113, 114, and 115. The second group of nodes 120 includes the nodes 121, 122, 123, 124, and 125, and the third group of nodes 130 includes the nodes 131, 132, 133, 134, and 135. Although FIG. 1 shows three locales with five nodes each, embodiments are not limited to any number of locales and nodes, and can include more or fewer locales and nodes than what is shown in FIG. 1. In an embodiment, a locale can include any sub-grouping of nodes. The sub-grouping of nodes may be based on any criteria. For instance, the sub-grouping of nodes may be based on a measure of the quality of the link between nodes (e.g., one or more performance metrics), based on geographic locations, or based on any other factors. Additionally, the sub-grouping of nodes can be either manually or automatically selected. For example, a person could manually assign nodes to a locale, or an automated machine could autonomously assign nodes to a locale randomly or using one or more performance metrics or any other criteria. Embodiments are not however limited to any particular manner of forming a locale, and a locale can include any sub-grouping of nodes.

Each node 111, 112, 113, 114, 115, 121, 122, 123, 124, 125, 131, 132, 133, 134, and 135 is optionally an active electronic device that is attached to the distributed communication system 100 and is capable of sending, receiving, or forwarding information over a communications channel. Some examples of nodes include data circuit-terminating equipment (DCE) such as a modem, hub, bridge, or switch, and data terminal equipment (DTE) such as a digital telephone handset, a printer, a host computer, a router, a workstation, or a server. In one particular embodiment, for illustration purposes only and not by limitation, a node comprises a Unified Communication Application Server. However, embodiments are not limited to any particular type of node. System 100 connects nodes 111, 112, 113, 114, 115, 121, 122, 123, 124, 125, 131, 132, 133, 134, and 135 together using links that enable telecommunication between nodes, and each node 111, 112, 113, 114, 115, 121, 122, 123, 124, 125, 131, 132, 133, 134, and 135 in system 100 has a unique address such that messages or connections can be routed to the correct node.

Each group of nodes is associated with multiple users. For instance, in FIG. 1, the first group of nodes 110 is associated with users 116. The second group of nodes 120 is associated with users 126, and the third group of nodes 130 is associated with users 136. Each group of users is distributed across its corresponding group of local nodes. For instance, arrow 117 represents users 116 being distributed across the first group of nodes 110. In an embodiment, users are distributed based at least in part on social network and/or collaboration history information. For example, users that are linked in a social network or that have collaborated in the past may be associated with a same node.

System 100 also includes a wide area network (WAN) 140 that enables communications across the locales. For instance, WAN 140 enables a communication 141 between nodes 113 and 121, and a communication 142 between nodes 113 and 131. In an embodiment, communications across WAN 140 may be reduced by utilizing social network and collaboration history information to predict which communications are most likely to occur. For example, if user 118 is linked to user 128 in a social network or if user 118 has collaborated with user 128 in the past, user 118′s local node 113 can cache user 128′s routing information in its local cache such that the routing information does not need to be obtained from a remote source.

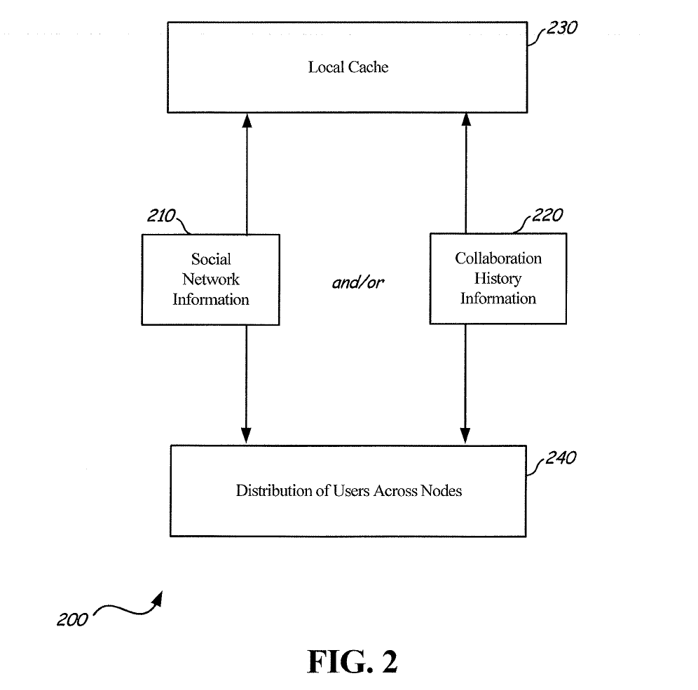

FIG. 2 is a schematic diagram of an embodiment of a distributed system 200 that utilizes social network information 210 and/or collaboration history information 220 to manage information stored to a local cache 230 and/or to distribute users across local nodes 240. Social network information 210 may be obtained from any social network source. Some examples of possible social network sources include, but are not limited to, a presence list, a buddy list, groups or teams on an enterprise social network, contacts, and a corporate directory (e.g., a corporate directory having organization information, group information, etc.). Similarly, collaboration history information 220 may be obtained from any collaboration source. Some examples of possible collaboration sources include, but are not limited to, a call log, an instant message history, presence updates, electronic mail, a calendar application, internet blogs, internet posts, internet comments, social networking follower information, and social networking mention information.

Social network information 210 may be used directly to manage information stored to a local cache 230 and/or to distribute users across local nodes 240. Additionally, one or more metrics may be derived from social network information 210. Some examples of metrics that may be derived from social network information 210 include, but are not limited to, cluster coefficients and list connected weights. The derived metrics illustratively provide an indication of which users in a social network are linked together. In one particular embodiment, cluster coefficients are used to distribute users across local nodes 240, and list connected weights are used to manage information stored to a local cache 230. Embodiments are not however limited to any particular implementation and any combination of direct social network information 210 and/or derived metrics can be used to manage information stored to a local cache 230 and/or distribute users across local nodes 240.

Collaboration history information 220 may also be used directly to manage information stored to a local cache 230 and/or to distribute users across local nodes 240. Additionally, one or more metrics may be derived from collaboration history information 220. Some examples of metrics that may be derived from collaboration history information 220 include, but are not limited to, predicted loads and likelihoods of communications. The derived metrics illustratively provide an indication of which users have communicated with each other. For example, the derived metrics can indicate which users communicate with each other frequently and which users communicate infrequently or not at all. In one particular embodiment, predicted loads are used to distribute users across local nodes 240, and likelihoods of communications are used to manage information stored to a local cache 230. Embodiments are not however limited to any particular implementation and any combination of direct collaboration history information 220 and/or derived metrics can be used to manage information stored to a local cache 230 and/or distribute users across local nodes 240.

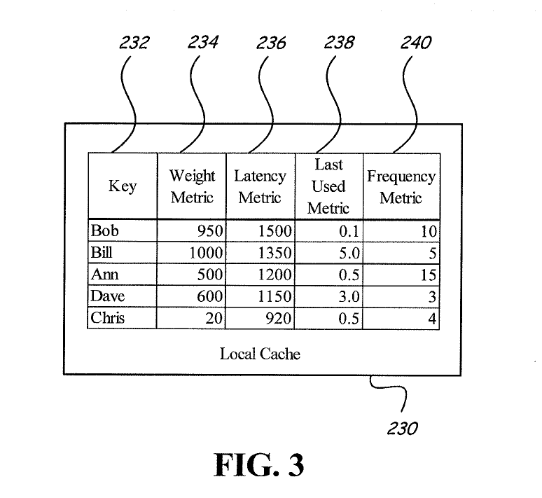

FIG. 3 is a more detailed view of an embodiment of the local cache 230 shown in FIG. 2. Local cache 230 includes information associated with keys 232. Keys 232 within the local cache 230 may be associated with keys from different locales. For instance, in the example shown in FIG. 3, the Bob and Bill keys may be associated with a first locale. The Ann and Dave keys may be associated with a second locale, and the Chris key may be associated with a third locale. Accordingly, local cache 230 can cache information from across a distributed system. This may reduce WAN traffic by enabling a node to retrieve data from a local node instead of having to retrieve it from a remote node across a WAN.

Local cache 230 may also store other information. In the specific example shown in FIG. 3, local cache 230 includes a weight metric 234, a latency metric 236, a last used metric 238, and a frequency metric 240 for each key 232. Weight metric 234 represents a likelihood that a particular communication route will be required. For example, communications routes that are more likely to be needed may have higher values for weight metric 234, and communication routes that are less likely to be needed may have lower values for weight metric 234. Weight metric 234 can be determined utilizing social network information (e.g., cluster coefficients) and/or collaboration history information (e.g., predicted loads).

Latency metric 236 represents a contribution to an overall system latency. In one embodiment, latency metric 236 is based on an amount of time required to retrieve routing information and a likelihood that the information will be needed. For example, if it would take a long time to retrieve routing information and it is predicted that the routing information will be needed (e.g. if the routing information has been used frequently in the past), then the latency metric 236 may have a higher value. Conversely, if it would take a short amount of time to retrieve routing information and/or it is predicted that the routing information is less likely to be needed (e.g., if the routing information has been used infrequently in the past), then the latency metric 236 may have a lower value.

Last used metric 238 represents how recently information in the cache was used, and frequency metric 240 represents how frequently information in the cache is used. The last used metric 238 may correspond to an amount of time since the data was last used. For example, routing information that has been used more recently may have a lower value for the last used metric 238 than routing information that has been used less recently. Similarly, routing information that has been used more frequently may have a higher value for the frequency metric than routing information that has been used less frequently.

Weight metric 234, latency metric 236, last used metric 238, and frequency metric 240 can be utilized to manage the data stored to local cache 230. For example, the weight metric 234, last used metric 238, and/or frequency metric 240 can be used to predict a likelihood that data will be needed in the future. Local cache 230 can retain data that is more likely to be used and/or is associated with a higher latency metric 236. Local cache 230 can evict data that is less likely to be used and/or is associated with a lower latency metric 236. Accordingly, the metrics can be used to manage cache data such that the overall system latency is reduced and cross-locale communications are reduced.

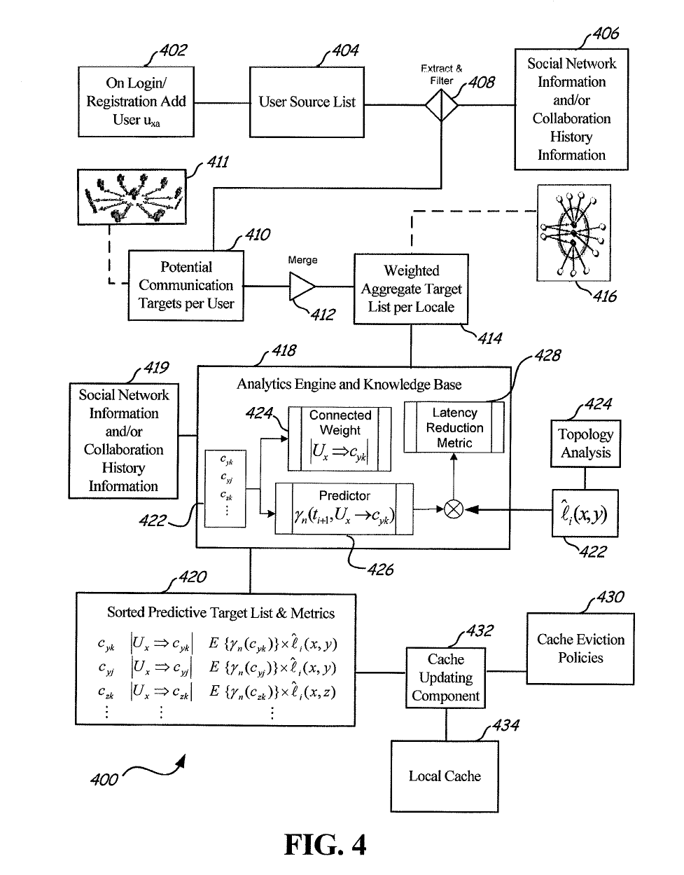

FIG. 4 is a schematic diagram of an embodiment of a system 400 that can be used to implement predictive caching in a distributed communication system. At block 402, a user “a” at locale “x” (i.e., uₓₐ) logs into or registers with system 400. A source list for that user is then generated at block 404. For example, based on the user's identity and locale, system 400 can generate a list of social network information sources and collaboration history information sources that are associated with the user. At block 406, system 400 obtains social network information and/or collaboration history information for the user. The social network information can be obtained from any social network and contact sources. For instance, the social network information can be obtained from any of the sources discussed above (i.e., a presence list, a buddy list, groups or teams on an enterprise social network, contacts, and a corporate directory) or any other possible sources of social network information. The collaboration history information can be obtained from any communication and collaboration events/history sources. For instance, the collaboration information can be obtained from any of the sources discussed above (i.e., a call log, an instant message history, presence updates, electronic mail, a calendar application, internet blogs, internet posts, internet comments, social networking follower information, and social networking mention information) or any other possible sources of communication and collaboration events/history information.

The user source list and the information from block 406 are then inputted into an extraction and filtering component at block 408. The output from the extraction and filtering component includes a set of information that identifies potential communication targets per a user (e.g., a list of potential communication targets for user uₓₐ). Block 411 schematically illustrates an example of a set of potential communication targets per a user. In block 411, the user is represented as the person in the center, and his or her potential communication targets form the circle surrounding the person.

In an embodiment, potential communication targets are determined for multiple different users of system 400. At block 412, the potential communication targets for the multiple different users are merged together by a merging component. The merged information is used to generate a weighted aggregate target list per locale at block 414. Block 416 schematically illustrates an example of a weighted target list. In block 416, the potential communication targets are represented by the dots that are inside the circle, and users of system 400 at other locales are represented by the dots outside the circle. The arrows between the users and the targets represent what targets are associated with each user. Targets that are associated with more users are optionally associated with a higher weight, and targets that are associated with fewer users are optionally associated with a lower weight. The weighted aggregate target list per locale at block 414 is then outputted to an analytics engine and knowledge base component at block 418.

Social network information and/or collaboration history information for the user at block 419 are also outputted to the analytics engine and knowledge base component at block 418. The social network information and/or collaboration history information can be obtained from any of the sources discussed above or any other possible sources. The information at block 419 may be the same or different than the information at block 406 depending upon the particular configuration of the system.

Additionally, latency information at block 422 may also be outputted to the analytics engine and knowledge base component at block 418. In one embodiment, the latency information may include an average latency estimation for communications between two different locales (e.g., between locales “x” and “y,” where “x” is a locale of a user, and “y” is a locale of a potential target of the user). The latency information can be determined using any methods or components. For instance, the latency information can be determined by utilizing network topology analysis at block 424.

The analytics engine and knowledge base component at block 418 utilizes the social network information and/or collaboration history information from block 419, the weighted aggregate target list per locale from block 414, and/or the latency information from block 422 to generate a sorted predictive target list and metrics at block 420.

The analytics engine and knowledge base component can use any method to generate the sorted predictive target list and metrics. Blocks 422, 424, 426, and 428 within block 418 illustrate one possible way to determine the sorted predictive target list and metrics. At block 422, a set of potential targets is obtained. Each target is associated with a contact and a locale. For example, in FIG. 4, “c_{yk}” represents that a target “c_{yk}” is associated with a contact “k” and a locale “y.” At block 424, connected weights are generated for each target. The connected weights represent how connected users at a particular locale are to a target. For example, FIG. 4 shows a connected weight for any user “U” at locale “x” for the target “c_{yk}.”

At block 426, a predictor component determines likelihoods (e.g., probabilities) that within a particular time, that any user in one locale will communicate with a target contact in another locale. For example, in FIG. 4, a likelihood that any user “U” at locale “x” will communicate with a target contact “k” in locale “y” at time “tᵢ₊₁” is determined. Likelihoods are optionally determined for each potential target (e.g., for each target shown in block 422).

Based on the likelihoods and the latency information, the analytics engine and knowledge base component determines a latency reduction metric at block 428. As discussed above, a latency metric optionally represents a contribution to an overall system latency. In one embodiment, the latency metric is based on an amount of time required to retrieve routing information and a likelihood that the information will be needed. For example, if it would take a long time to retrieve routing information and it is predicted that the routing information will likely be needed, then the latency metric may have a higher value. Conversely, if it would take a short amount of time to retrieve routing information and/or it is predicted that the routing information is less likely to be needed, then the latency metric may have a lower value. Latency metrics may be determined for each potential target (e.g., for each target shown in block 422).

The analytics engine and knowledge base component at block 418 is not limited to the particular methods and metrics described above. For instance, in the embodiment described above, a latency metric is determined that can be used to reduce an overall system latency. However, in another embodiment, an overall system latency may not be reduced. Instead, potential targets may be associated with a priority metric. For example, an important contact may have a higher priority metric than a less important contact. Accordingly, the analytics engine and knowledge base component may use metrics and methods that reduce latency based on priority metrics of contacts and not based on reducing an overall system latency. Thus, embodiments of the present disclosure are not limited to any particular methods and metrics, and the analytics engine and knowledge base component can use any methods and metrics to optimize any system parameter as desired.

At block 420, a sorted predictive target list and metrics are generated. In the example shown in FIG. 4, each row corresponds to a target (e.g., c_{yk}, c_{yj}, c_{zk}), and each row includes metrics associated with the target (e.g., a connected weight and a latency reduction metric). The target list and metrics may be sorted based on locales of the targets, based on one or more of the metrics, or based on any other feature. Additionally, the metrics are not limited to any particular metrics and can include any one or more metrics used by system 400.

The sorted predictive target list and metrics from block 420 and cache eviction policies from block 430 are inputted into a cache updating component 432. The cache eviction policies include criteria for removing information from a cache. Some examples of cache eviction policies include, but are not limited to, removing information that has a lower impact on reducing latency, removing information that has a lower connected weight, removing information that is used less recently, and removing information that is used less frequently.

The cache updating component at block 432 utilizes the sorted predictive target list and the cache eviction policies to update a local cache at block 434. For instance, the cache updating component may add information to the local cache that may reduce latency, has a higher connected weight, was used more recently, has a higher priority, or is used more frequently. Also for instance, the cache updating component may remove information from the local cache that has a lower impact on reducing latency, has a lower connected weight, was used less recently, has a lower priority, or is used less frequently. Accordingly, system 400 can be used to manage what information is stored by a local cache, and system 400 can be configured to manage the cache to reduce an overall system latency, prioritize certain contacts, or achieve other criteria as desired.

As has been described above, embodiments of systems and methods provide predictive caching in a distributed communication system. In one embodiment, social network and collaboration history information are utilized to determine what communication routes are most likely to be required, and a local cache can then store the needed routing information. Accordingly, social network and collaboration history information can be used to predict what routing information is most likely to be needed at a local cache. This may be beneficial in reducing system latency and cross-locale communications (e.g. communications across a wide area network) by reducing the amount of routing information that needs to be obtained from remote sources. In another embodiment, social network and collaboration history information are utilized to distribute users in a communications system. For instance, users that are linked in a social network or have a history of collaborating may be associated with a same node (e.g., a same local server). Therefore, users that are more likely to communicate with each other can be associated with a same node, and this may also be beneficial in reducing system latency and cross-locale communications. Additionally, embodiments may reduce overall use of system resources, thereby increasing the scalability of a multi-node system. Embodiments are not however limited to any particular benefits or features and may include any one or more of the features described above or shown in the figures.

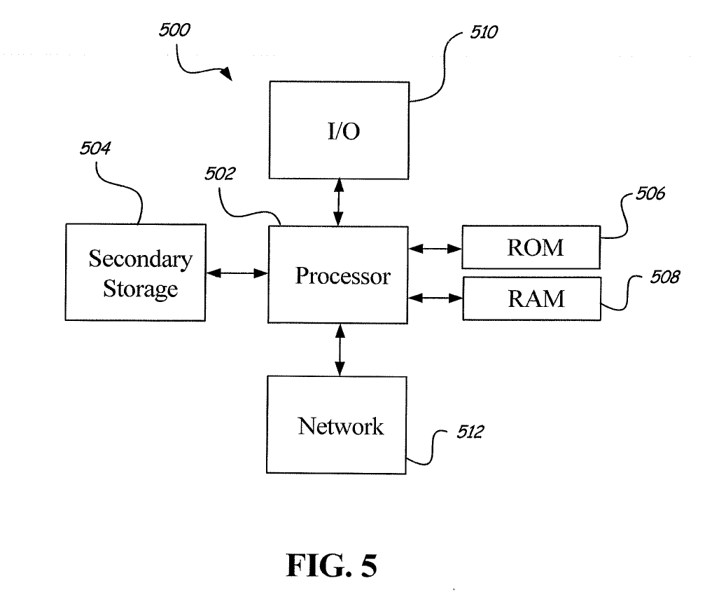

The schemes described above may be implemented on any general-purpose network component, such as a computer or network component with sufficient processing power, memory resources, and network throughput capability to handle the necessary workload placed upon it. FIG. 5 illustrates a schematic diagram of a general-purpose network component or computer system 500 suitable for implementing one or more embodiments of the methods disclosed herein. The general-purpose network component or computer system 500 includes a general-purpose processor 502 (which may be referred to as a central processor unit or CPU) that is in communication with memory devices including secondary storage 504, read only memory (ROM) 506, random access memory (RAM) 508, input/output (I/O) devices 510, and network connectivity devices 512. Although illustrated as a single processor, the processor 502 is not so limited and may comprise multiple processors. The processor 502 may be implemented as one or more CPU chips, cores (e.g., a multi-core processor), field-programmable gate arrays (FPGAs), application specific integrated circuits (ASICs), and/or digital signal processors (DSPs), and/or may be part of one or more ASICs. The processor 502 may be configured to implement any of the schemes described herein. The processor 502 may be implemented using hardware, software, or both.

The secondary storage 504 is typically comprised of one or more disk drives or tape drives and is used for non-volatile storage of data and as an over-flow data storage device if the RAM 508 is not large enough to hold all working data. The secondary storage 504 may be used to store programs that are loaded into the RAM 508 when such programs are selected for execution. The ROM 506 is used to store instructions and perhaps data that are read during program execution. The ROM 506 is a non-volatile memory device that typically has a small memory capacity relative to the larger memory capacity of the secondary storage 504. The RAM 508 is used to store volatile data and perhaps to store instructions. Access to both the ROM 506 and the RAM 508 is typically faster than to the secondary storage 504.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 70 percent, 71 percent, 72 percent, . . . , 95 percent, 96 percent, 97 percent, 98 percent, 99 percent, or 100 percent. Moreover, any numerical range defined by two R numbers as defined in the above is also specifically disclosed. The use of the term about means +10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method for managing information stored to a local cache comprising:
obtaining social networking information and/or collaboration history information for a user;
identifying potential targets of communication for the user based at least in part on the social networking information and/or the collaboration history information; and
updating the local cache based at least in part on the identified potential targets of communication using a processor.

2. The method of claim 1, further comprising dynamically distributing users within a locale using the social networking information and/or the collaboration history information.

3. The method of claim 1, further comprising determining metrics for the potential targets of communication using the social networking information and/or the collaboration history information, and wherein updating the local cache comprises updating the local cache based at least in part on the metrics.

4. The method of claim 3, wherein determining the metrics for the potential targets of communication comprises determining latency reduction metrics.

5. The method of claim 3, wherein determining the metrics for the potential targets of communication comprises determining weight metrics.

6. The method of claim 1, wherein updating the local cache comprises applying a set of cache eviction policies.

7. An apparatus for managing information stored to a local cache comprising:
an analytics engine component that is configured to determine metrics for potential targets of communication using social networking information and/or collaboration history information; and
an updating component that is configured to add or remove information corresponding to at least one of the potential targets of communication from the local cache using the metrics.

8. The apparatus of claim 7, wherein the potential targets of communication are determined based at least in part on the social networking information and/or the collaboration history information.

9. The apparatus of claim 7, further comprising a distribution component that is configured to distribute users within a locale based at least in part on the metrics.

10. The apparatus of claim 7, wherein the metrics comprise a latency reduction metric.

11. The apparatus of claim 7, wherein the metrics comprise a weight metric.

12. The apparatus of claim 7, wherein the updating component is configured to use a cache eviction policy.

13. An apparatus for managing information stored to a local cache comprising:
a processor configured to:
determine a potential communication target for a user;
calculate a probability value that represents a likelihood that the user will communicate with the potential communication target; and
update the local cache based at least in part on the calculated probability value.

14. The apparatus of claim 13, wherein the processor is configured to identify the potential communication target using social networking information.

15. The apparatus of claim 13, wherein the processor is configured to calculate the probability value using collaboration history information.

16. The apparatus of claim 13, wherein the processor is configured to distribute users within a locale using the probability value.

17. The apparatus of claim 13, wherein the processor is configured to determine a latency value associated with communications between the user and the potential communication target, and wherein the processor is configured to update the local cache using the calculated probability value and the latency value.

18. The apparatus of claim 13, wherein the processor is configured to apply a cache eviction policy to the potential communication target to update the local cache.

19. The apparatus of claim 13, wherein the processor is configured to determine a weight metric for the potential communication target and store the weight metric in the local cache.

20. The apparatus of claim 13, wherein the processor is configured to determine a latency metric for the potential communication target and store the latency metric in the local cache.
